(19) United States
(12) Patent Application Publication
(10) Pub. No.: US 2005/0167533 A1
(43) Pub. Date: Aug. 4, 2005

(54) Apparatus for spreading particulate material from a work vehicle

(76) Inventors: Jody M. Christy, Iron Mountain, MI (US); Chris Kuzak, Channing, MI (US)

Correspondence Address: QUARLES & BRADY LLP, 411 E. WISCONSIN AVENUE, SUITE 2040, MILWAUKEE, WI, 53202-4497, US

(21) Appl. No.: 10/751,769

(22) Filed: Jan. 5, 2004

(51) Int. Cl. A01C 17/00

(52) U.S. Cl. 239/668

(57) ABSTRACT

A spreader is provided with a lift mechanism to facilitate attachment to and detachment from a work vehicle. A hitch is permanently mounted on the work vehicle and has a pair of slots. A hopper is provided to hold the material being distributed by the spreader. The lift mechanism has a first member that is attached to the hopper, and a second member that has a pair of latch pins that are releasably received in the pair of slots. A linear actuator produces movement between the first and second members and thus between the hopper and the hitch when the latch pins are in the slots.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to equipment for spreading particulate material, such as sand or salt, from a truck or other type of work vehicle; and more particularly to mounts for removably attaching such equipment to the work vehicle wherein those mounts include a lifting mechanism.

2. Description of the Related Art

In the winter, sand and/or salt is spread on snow and ice covered roads using a spreader mounted to the rear of a truck. These spreaders are hung by hooks on the tail gate of the truck or otherwise attached to the truck's body or frame. The spreader has a hopper into which the material being distributed is loaded. Typically the hopper has a lower section that tapers toward an opening so as to funnel the material through that opening. In a gravity fed model, a gate controls flow of the material from the hopper onto the road behind the truck. In other models, the spreader includes a motor driven centrifugal impeller onto which the material drops from the hopper and then is ejected in a semicircular pattern behind the truck.

It is necessary to remove the spreader from the truck in order to load objects into the truck bed and use the vehicle for other purposes. As a consequence, it is desirable to be able to mount and dismount the spreader as easily as possible. However, a spreader, especially one containing a load of salt or sand, is relatively heavy and usually requires the use of other equipment, such as a fork lift or front end loader, to move the spreader onto and off the truck.

Therefore, it would be advantageous to provide a self-mounting spreader.

### SUMMARY OF THE INVENTION

A spreader for distributing material includes a hitch attached to a work vehicle, a hopper and a lift mechanism that removably couples the hopper to the hitch. The hopper is provided to hold the material and has an outlet through which the material is discharged. The hitch has a pair of primary connector elements, such as slots for example. The lift mechanism is attached to the hopper and has first and second secondary connector elements, such as latch pins for example, that releasably engage the pair of primary connector elements on the hitch. Specifically, the lift mechanism includes a first member secured to the hopper, a second member, and an actuator which produces motion between the first and second members. For example, the actuator may be a powered actuator, such as a hydraulic cylinder or an electric motor, or a manually operated device, such as a screw jack. Operation of the actuator changes a positional relationship between the hopper and at least one of the first and second secondary connector elements to secure the lift mechanism to the hitch.

In one embodiment of the spreader, the lift mechanism includes first and second arms that are pivotally connected to both the hopper and a link arrangement. The first and second secondary connector elements are on the link arrangement and releasably engage the primary connector elements. The actuator is connected to the hopper and either the first arm or the link arrangement to produce movement of the first and second secondary connector elements with respect to the hopper. A stand optionally is connected to the hopper to support the spreader when the lift mechanism is detached from the hitch.

In another embodiment of the spreader, the lift mechanism includes a first guide connected to the hopper. A stand has a first member that is slidably received in the first guide, a first secondary connector element is coupled to the first guide and a second secondary connector element is coupled to the stand. The actuator is connected to the stand and the first guide to move the first and second secondary connector elements toward and away from each other and into an out of engagement with the first pair of primary connector elements of the hitch.

### BRIEF DESCRIPTION OF THE DRAWINGS

FIG. 1 is a side view of a spreader attached to a pick-up truck by means of a mounting mechanism according to the present invention;

FIG. 2 is a front view of a first embodiment the spreader and mounting mechanism;

FIG. 3 is a side view of the spreader in a raised operational position;

FIG. 4 is a side view of the spreader resting on the ground in a lowered position detached from the pick-up truck;

FIG. 5 is a front view of a second embodiment the spreader and mounting mechanism;

FIG. 6 is a side view of the second embodiment of the spreader in a raised operational position;

FIG. 7 is a side view of the second embodiment of the spreader resting on the ground detached from the pick-up truck; and

FIG. 8 illustrates an alternative connection of a linear actuator to links in a lift mechanism of the spreader.

### DETAILED DESCRIPTION OF THE INVENTION

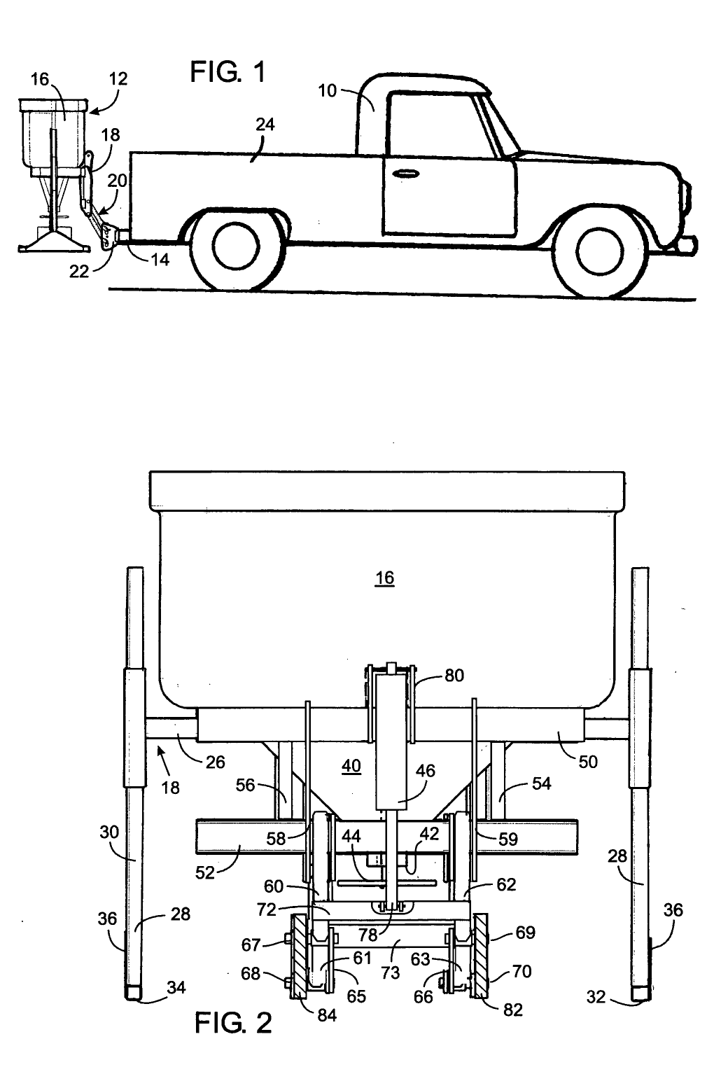

With initial reference to FIG. 1, a work vehicle 10, such as a pickup truck for example, has a material spreader 12 attached to its rear bumper 14 or the frame of the vehicle. For example, the spreader can be employed to broadcast sand or salt from the rear of the vehicle onto ice or snow covered roads. The spreader 12 comprises a hopper 16 mounted on a base 18, and includes a lift mechanism 20 which engages a hitch 22 on the work vehicle 10. As will be described, the lift mechanism can disengage from the hitch 22, enabling the spreader 12 to be removed from the vehicle. However, the hitch 22 is permanently attached to either the bumper or to the frame of the work vehicle 10. The mount 22 is below the floor of the load bed 24 of the work vehicle 10 and thus below the tailgate in the lowered in the horizontal position so as not to interfere with the loading and unloading of objects when the spreader 12 is detached.

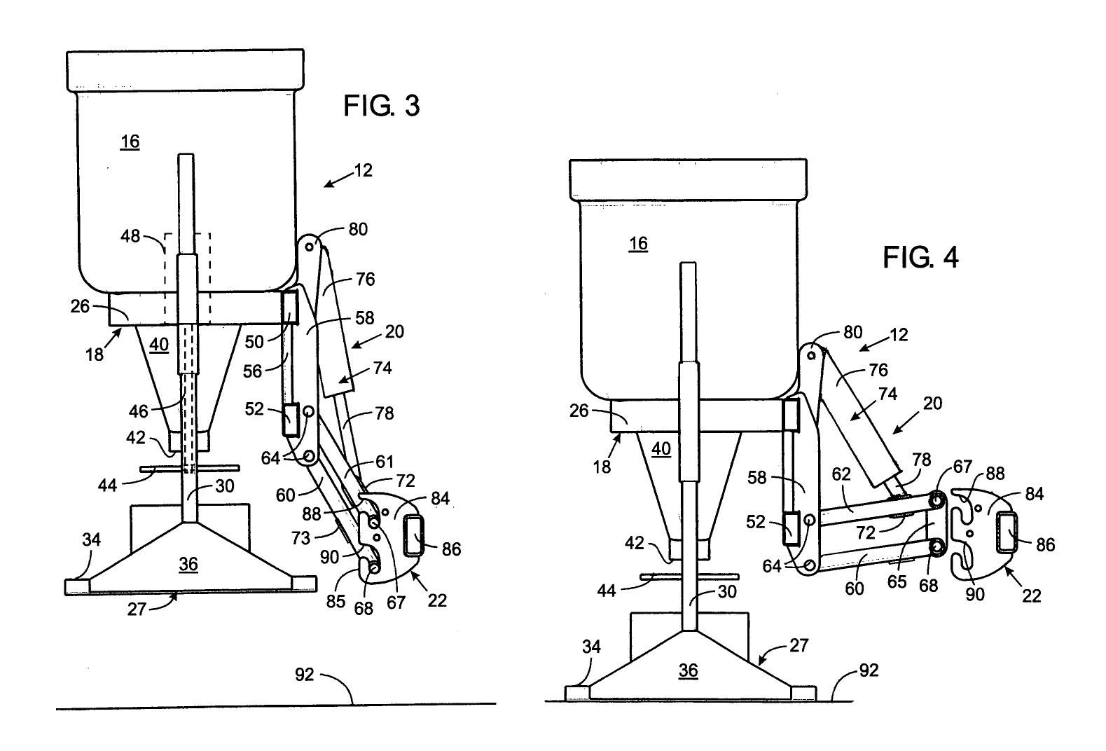

With reference to FIGS. 2 and 3, the hopper 16 has a open top through which the particulate material to be distributed is loaded. The open top may be closed by a removable cover. The hopper 16 has a funnel section 40 at the bottom which tapers to an outlet opening 42. An impeller 44 is located beneath the outlet opening 42 and is attached to the end of a shaft 46 which extends upward through the funnel section 40 to a motor 48 located within the hopper as in previous material spreaders. The motor 48 may be electrically or hydraulically driven. An auger (not visible) may be positioned on the shaft 46 within the outlet opening 42 has a pitch and a sufficient number of turns to preclude the particulate material from flowing through the outlet opening 42 unless the shaft 46 is being rotated by the motor 48. Alternatively, the motor can be located beneath the impeller 44 on a section of the spreader body 18. When the motor 48 is powered, the auger carries particulate material from the funnel section 40 through the outlet opening 42 and onto the spinning impeller 44. This broadcasts the particulate material from the hopper 16 radially outward from the impeller, covering a wide area of road surface.

The hopper 16 rests on a horizontal support 26 of the body 18. The horizontal support 26 extends laterally beyond the sides of the hopper where the horizontal support is connected to a stand 27 which supports the spreader 12 when detached from the work vehicle 10. The stand 27 comprises two vertical legs 28 and 30 that extend downward from the horizontal support 26 and have bottom ends attached to feet 32 and 34, respectively. A gusset 36 reinforces each junction between the vertical members 28 and 30 and the feet 32 and 34.

The forward edge of the body 18 is attached to a lift mechanism 20. Specifically, the body's horizontal support 26 is attached to a vertical frame formed by a pair of horizontal beams 50 and 52 connected by a pair of vertical beams 54 and 56. A pair of vertical plates 58 and 59 are welded to the horizontal beams 50 and 52 and project toward the work vehicle 10. First and second parallel arms 60 and 61 are pivotally connected by a pair of trunnions 64 to the first vertical plate 58. Third and fourth parallel arms 62 and 63 are pivotally connected by another pair of trunnions 64 to the second vertical plate 59, respectively. The details of the connection of the first and second arms 60 and 61 is shown in FIG. 3 with the understanding that the third and fourth arms 62 and 63 are connected in a similar manner. With additional reference to FIG. 4, the remote ends of the four arms 60-63 are connected to a link arrangement formed by first and second links 65 and 66. Specifically, the first and second arms 60 and 61 are pivotally connected by first and second pins 67 and 68 to a first link 65. The remote ends of the third and fourth arms 62 and 63 are pivotally connected by third and fourth pins 69 and 70 to a second link 66. The first, second, third and fourth pins 67-70 project outward from the respective arms 60-63 as seen in FIG. 2. A first cross plate 72 is welded to the upper first and third arms 60 and 62. As will be described, the combination of the vertical plate 58, first and second arms 60 and 61, and links 65 forms a parallelogram lift assembly on one side of the spreader 12, while the combination of the vertical plate 59, third and fourth arms 62 and 63, and links 66 forms a parallelogram lift assembly on the other side. A second cross plate 73 is connected between the lower second and fourth arms 61 and 63.

The lift mechanism 20 includes a linear actuator 74, preferably comprising a hydraulic cylinder 76 and a piston with a rod 78, however an electric or hydraulic motor and a drive screw also could be employed. Alternatively the linear actuator 73 may be a manually operated device, such as a screw jack. One end of the cylinder 76 is pivotally connected to a bracket 80 which extends upward from the center of the upper beam 50. The remote end of the piston rod 78 is pivotally connected to the center of the first cross plate 72 extending between the upper first and third arms 60 and 62. Alternatively as shown in FIG. 8, the first cross plate 72 could be connected to the first and second links 65 and 66 and thus be part of the link arrangement. In this latter version, the lifting force from the actuator 74 is applied directly to the link arrangement.

With continuing reference to FIGS. 2 and 3, the hitch 22 comprises first and second receiving brackets 82 and 84. The first and second receiving brackets are flat plates which are spaced apart and welded to a box beam 86 that is secured to the bumper 14 of the work vehicle. Alternatively the box beam 86 can have members which project underneath the work vehicle for attachment to the vehicle's frame. Each receiving bracket 82 and 84 has a pair of downwardly curving slots 88 and 90 which extend from a vertical edge 85. The pair of slots 88 and 90 form primary connector elements that are sized to receive the second pins 68 on the lift mechanism 20 which form secondary connector elements in this embodiment of the spreader. Alternatively, the primary connector elements on the hitch 22 could comprise pins and the secondary connector elements of the lift mechanism 20 could be mating slots. As a further variation of the present inventive concept, each of the hitch 22 and the lift mechanism 20 could have both a pin and a slot which engage each other. The primary and secondary connector elements also may comprise moveable pins in either the hitch or lift mechanism that engage mating apertures in the other one of the hitch or lift mechanism.

FIG. 4 illustrates the spreader 12 detached from the vehicle with the second pins 68 of the lift mechanism 74 withdrawn from the curved slots 88 and 90 in the hitch 22. In this state, the stand feet 32 and 34 of the spreader body 18 rest on the surface of the ground 92. To attach the spreader 12, the work vehicle 10 is driven adjacent the spreader so that the hitch 22 is closely spaced with respect to the ends of the lift mechanism arms 60 and 62. The hydraulic cylinder 76 is connected by hoses (not shown) to hydraulic fittings on the work vehicle and the hydraulic cylinder is activated so that the first and second pins 67 and 68 are aligned horizontally with the openings of the curved slots 88 and 90 in the hitch brackets 82 and 84 on opposite sides of the spreader. Then the work vehicle 10 and the spreader are moved toward each other so that the second pins 68 enter the curved slots 88 and 90. The hydraulic cylinder 76 is then powered to extend the piston rod 78 there from to push the second pins 68 downward to the bottoms of the curved slots 88 and 90. Continued extension of the piston rod 78 from the cylinder 76 raises the spreader 12 off the ground 92, as illustrated in FIG. 3. Upon being raised from the ground, the weight of the spreader is shifted onto the hitch 22 and maintains the second pins 68 in the curved slots 88 and 90. Because of the parallelogram arrangements, which each have of a pair of arms 60-61 or 62-63 with a link 65 or 66 and a vertical bracket 58 or 59, the spreader 12 remains vertical as it is raised onto the work vehicle.

Reversing the process by operating the cylinder 76 to retract the piston rod 78 causes the spreader 12 to move downward from the raised operating position in FIG. 3, eventually contacting the ground as shown in FIG. 4. In the lowered position, the spreader can be separated from the hitch 22 on the work vehicle 10.

Therefore, even if the spreader 12 is heavily loaded with sand, the lift mechanism 20 allows easy attachment and detachment to the rear of the work vehicle 10 without requiring additional lifting equipment.

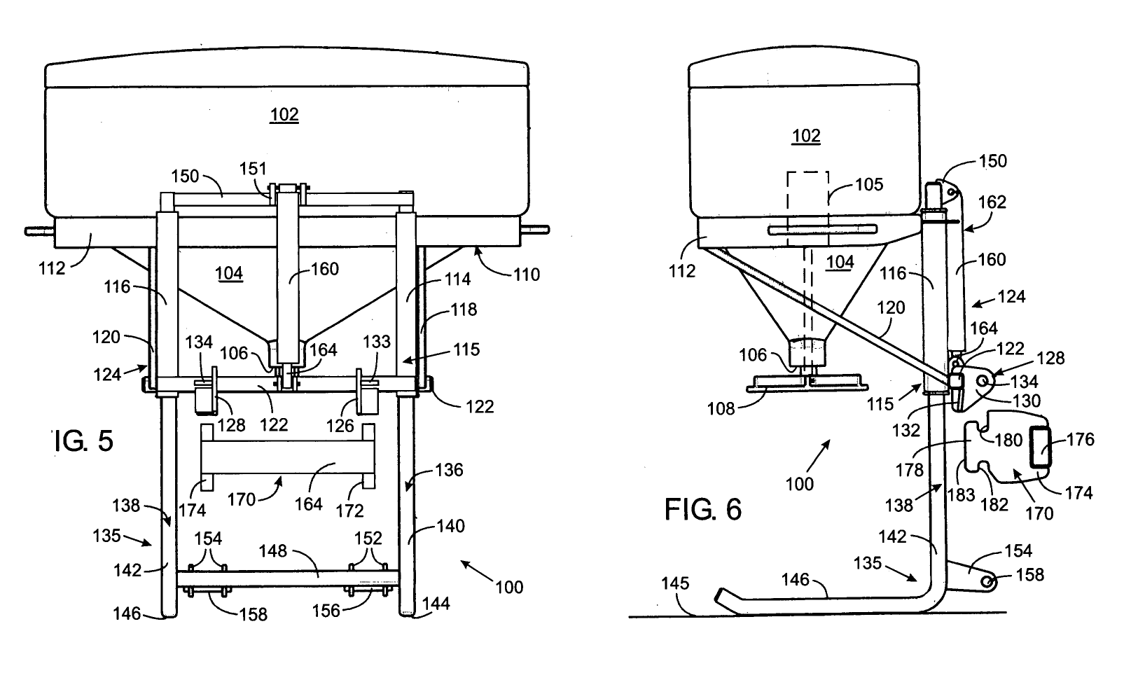

With reference to FIGS. 5 and 6, a second embodiment of a spreader 100 according to the present invention has a hopper 102 with a lower funnel section 104 which tapers to an outlet opening 106 at the bottom. An impeller 108 rotates beneath the outlet opening 106 to propel the material being distributed as was described with respect to the first embodiment. A motor 105 located within the hopper 102 rotationally drives the impeller 108.

The hopper 102 is mounted on a body 110 which includes a horizontal support 112 to which a lift mechanism 124 is attached. The lift mechanism 124 has a frame 115 that includes a pair of tubular guides 114 and 116 and a first cross bar 122. The tubular guides 114 and 116 are connected to the forward edge of the horizontal support 112 and extend downward in a spaced-apart fashion. The first cross bar 122 is connected between the lower sections of the two tubular guides 114 and 116. Two brace rods 118 and 120 are to the rear of the horizontal support 112 and to opposite ends of the first cross bar 122. A pair of spaced-apart upper latch brackets 126 and 128 are secured to the first cross bar 122. Each upper latch bracket 126 and 128 is formed by two metal plates 130 and 132 welded at right angles to one another and to the first cross bar 122 of the spreader body. Each upper latch bracket 126 and 128 has pins 133 and 134 projecting horizontally there from.

The lift mechanism 124 includes a stand 135 having a pair of L-shaped legs 136 and 138 each having a vertical section 140 and 142, respectively, which pass through the tubular guides 114 and 116. The stand legs 136 and 138 have horizontal sections 144 and 146 project under the hopper 102 from the lower ends of the vertical sections 140 and 142, respectively. The horizontal sections 144 and 146 of the stand 135 rest on the ground 145 when the spreader 100 is detached from the work vehicle. A lower cross bar 148 and an upper cross bar 150 are connected between the vertical sections 140 and 142 being welded thereto. A first pair of brackets 152 are welded near one end of the lower cross bar 148 and has a pin 156 extending there between. A second pair of brackets 154 are welded near the other end the lower cross bar 148 and has another pin 158 extending there between. The upper cross bar 150 has two tabs 151 to which the upper end of a hydraulic cylinder 160 of a lift actuator 162 is pivotally attached. A piston rod 164 extends from the cylinder 160 and has a remote end that is pivotally connected to the tabs 151 on the upper first cross bar 122.

Vehicle hitch 170 has a pair of plates 172 and 174 mounted to a box beam 176 in much the same manner as with hitch 22 in the first embodiment 12 of the spreader. However in the second embodiment 100, each hitch plate 172 and 174 has a T-shaped tongue 178 that defines upper and lower slots 180 and 182. As will be described, the upper and lower slots 180 and 182 receive the pins 133, 134, 156 and 158 of the spreader lift mechanism 124.

To attach the spreader 100, the motor vehicle 10 is backed toward the spreader so that the hitch 170 is located between the upper latch brackets 126 and 128 and the lower latch brackets 152 and 154 as shown in FIG. 6. Specifically slots 180 and 182 in the two hitch plates are vertically aligned with the pins 133, 134, 156 and 158 in the latch brackets. A power conduit, a hydraulic line in the case of a cylinder or an cable in the case of an electric motor, is attached to a supply connector on the vehicle. In the case of the hydraulic cylinder 160, hydraulic fluid is pumped thereto to extend the rod 164 from the cylinder. This lowers the tubular guides 114 and 116 on the vertical legs 140 and 142 of the stand 135 which also lowers the upper latch brackets 126 and 128. Eventually the upper latch pins 133 and 134 enter the upper slots 180 in the hitch 170. The spreader 100 is then supported by the hitch 170 so that further extension of the piston rod 164 raises the stand 135 from the ground 145. Engagement of the plate 132 of the upper latch brackets 126 and 128 with the vertical edge 183 of the tongues 178 on the two hitch brackets 182 and 184 prevents the spreader 100 from pivoting about the upper latch pins 133 and 134 as the stand 135 raises off the ground.

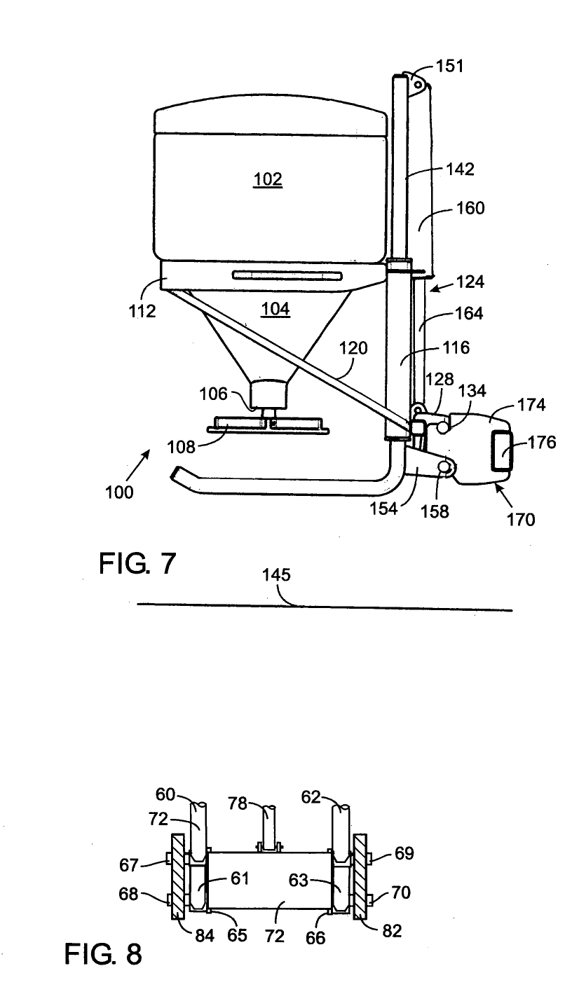

Movement of the stand 135 upward through the tubular supports 116 and 118 continues until the pins 156 and 158 of the lower latch brackets 152 and 154 enter the lower slots 182 of the hitch 170 as shown in FIG. 7. When these lower pins reach the uppermost region of the hitch slots 182, the pins of the latching brackets 126, 128, 152 and 154 hold the spreader 100 securely on the hitch 170.

Reversal of the lift actuator 162 detaches the spreader 100 from the vehicle hitch 170. In this mode of operation, the rod 164 is retracted into the cylinder 160 thereby lowering the stand 135. Initially the lower latch pins 158 drop out of the lower hitch slots 182. After the stand 135 rests on the ground 145, continued retraction of the rod 164 raises the upper latch brackets 126 and 128 away from the hitch 170 into a detached position illustrated in FIG. 6.

The foregoing description was primarily directed to a preferred embodiment of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

1. A spreader for distributing material from a work vehicle and comprising:
a hitch for fixed connection to the work vehicle and having a pair of primary connector elements;
a hopper for holding the material and having an outlet through which the material is discharged; and
a lift mechanism attached to the hopper and having first and second secondary connector elements releasably engaging the pair of primary connector elements, the lift mechanism includes a first member secured to the hopper, a second member, and an actuator connected to the first member and to the second member, wherein operation of the actuator changes a positional relationship between the hopper and at least one of the first and second secondary connector elements to secure the lift mechanism to the hitch.

2. The spreader as recited in claim 1 further comprising a stand attached to the hopper for supporting the spreader when the lift mechanism is detached from the hitch.

3. The spreader as recited in claim 1 wherein the first and second secondary connector elements of the lift mechanism are attached to the second member, and the lift mechanism further comprises first and second arms pivotally connected to the first and second members.

4. The spreader as recited in claim 3 wherein the actuator is connected to one of the second member and the first arm.

5. The spreader recited in claim 1 wherein the actuator is selected from a group consisting of a hydraulic cylinder, a motor, and a manual screw jack.

6. The spreader recited in claim 1 wherein the primary connector elements comprise a pair of slots, and first and second secondary connector elements comprise first and second latch pins.

7. The spreader as recited in claim 6 wherein the first member of the lift mechanism comprises a guide attached to the hopper and a bracket connected to the guide and from which the first latch pin extends, and the second member slides in the guide and has the second latch pin extending there from, wherein the actuator moves the first and second latch pins toward and away from each other and into and out of engagement with the pair of slots of the hitch.

8. The spreader as recited in claim 7 wherein the guide is tubular.

9. A spreader for distributing material from a work vehicle and comprising:
a hitch for fixed connection to the work vehicle and having a first pair of primary connector elements;
a hopper for holding the material and having an outlet through which the material is discharged;
a lift mechanism having first and second arms pivotally connected to both the hopper and a link arrangement, first and second secondary connector elements on the link arrangement and releasably received in the first pair of primary connector elements, the lift mechanism including an actuator connected to the hopper and to one of the first arm and the link arrangement to produce movement of the first and second secondary connector elements with respect to the hopper.

10. The spreader as recited in claim 9 further comprising a stand attached to the hopper for supporting the hopper when the lift mechanism is detached from the hitch.

11. The spreader recited in claim 9 wherein the primary connector elements comprise a first pair of slots, and first and second secondary connector elements comprise first and second latch pins extending from the link arrangement.

12. The spreader as recited in claim II wherein the hitch comprises a receiving bracket having a vertical edge from which each of the first pair of slots curve downward.

13. The spreader as recited in claim 11 wherein:
the hitch has a second pair of slots; and
the lift mechanism further comprises third and fourth arms pivotally connected to the hopper and pivotally connected to the link arrangement by third and fourth latch pins that also are releasably received in the second pair of slots.

14. The spreader as recited in claim 9 wherein the first and second arms are parallel to each other, and the third and fourth arms are parallel to each other.

15. The spreader recited in claim 9 wherein the actuator is selected from a group consisting of a hydraulic cylinder, a motor, and a manual screw jack.

16. A spreader for distributing material from a work vehicle, the spreader comprising:
a hitch for fixed connection to the work vehicle and having a first pair of primary connector elements spaced apart vertically and a second pair of primary connector elements spaced apart vertically;
a hopper for holding the material and having an outlet through which the material is discharged;
a lift mechanism including first and second arms pivotally connected to both the hopper and a first link, and first and second secondary connector elements attached to the first link and releasably engaging the first pair of primary connector elements, the lift mechanism further including third and fourth arms pivotally connected to the hopper and to a second link, and third and fourth secondary connector elements attached to the second link and releasably engaging the second pair of primary connector elements, the lift mechanism has an actuator connected to the hopper and to one of both the first and third arms and both of the first and second links.

17. The spreader recited in claim 16 wherein the first pair of primary connector elements comprise a first pair of slots, the second pair of primary connector elements comprise a second pair of slots, and the first, second, third and fourth secondary connector elements respectively comprise first, second, third and fourth latch pins.

18. The spreader as recited in claim 17 wherein the hitch comprises a first receiving bracket having a vertical edge from which first pair of slots curve downward, and a second receiving bracket having another vertical edge from which the second pair of slots curve downward.

19. The spreader as recited in claim 18 wherein the first receiving bracket is spaced apart horizontally from the second receiving bracket.

20. The spreader as recited in claim 16 further comprising a stand attached to the hopper for supporting the hopper when the lift mechanism is detached from the hitch.

21. A spreader for distributing material from a work vehicle, the spreader comprising:
a hitch for fixed connection to the work vehicle and having a first pair of primary connector elements;
a hopper for holding the material and having an outlet through which the material is discharged;
a lift mechanism having a first guide connected to the hopper, a stand with a first member slidably received in the first guide, a first secondary connector element coupled to the first guide, a second secondary connector element coupled to the stand, and an actuator connected to the stand and the first guide to move the first and second secondary connector elements toward and away from each other and into and out of engagement with the first pair of primary connector elements of the hitch.

22. The spreader as recited in claim 21 wherein:
the hitch has a second pair of primary connector elements; and
a lift mechanism further comprises a second guide connected to the hopper, the stand has a second member slidably received in the second guide, a third secondary connector element coupled to the second guide and a fourth secondary connector element coupled to the stand, wherein the actuator moves the third and fourth secondary connector elements toward and away from each other and into and out of engagement with the second pair of primary connector elements of the hitch.

23. The spreader recited in claim 22 wherein the first primary connector elements comprise a first pair of slots, the second primary connector elements comprise a second pair of slots, and the first, second, third and fourth secondary connector elements respectively comprise first, second, third and fourth latch pins.

24. The spreader as recited in claim 23 wherein the lift mechanism further comprises a cross bar connected between the first member and the second member and having one latch bracket from which the second latch pin projects and another latch bracket from which the fourth latch pin projects.

25. The spreader as recited in claim 23 wherein the hitch comprises a receiving bracket having an upper edge from which one of the first pair of slots extends and a lower edge from which another one of the first pair of slots.

26. The spreader as recited in claim 22 wherein the first guide and the second guide are tubes.

27. The spreader as recited in claim 22 wherein the hitch comprises a first receiving bracket having an upper edge from which one of the first pair of primary connector elements extends and a lower edge from which another one of the first pair of primary connector elements extends, and a second receiving bracket having an upper edge from which one of the second pair of primary connector elements extends and a lower edge from which another one of the second pair of primary connector elements extends.

28. The spreader recited in claim 21 wherein the actuator is selected from a group consisting of a hydraulic cylinder, a motor, and a manual screw jack.
